(19) United States
(12) Patent Application Publication
(10) Pub. No.: US 2020/0163198 A1
(43) Pub. Date: May 21, 2020

(54) OPTIMIZED NEUTRODE STACK COOLING FOR A PLASMA GUN

(71) Applicant: OERLIKON METCO (US) INC., Westbury, NY (US)

(72) Inventors: Ronald J. MOLZ, Farmingville, NY (US); Dave HAWLEY, Westbury, NY (US); Jose COLMENARES, Malverne, NY (US)

(73) Assignee: OERLIKON METCO (US) INC., Westbury, NY (US)

(21) Appl. No.: 16/493,479

(22) PCT Filed: Mar. 14, 2018
(86) PCT No.: PCT/US18/22373

§ 371 Date: Sep. 12, 2019

Related U.S. Application Data
(60) Provisional application No. 62/472,202, filed on Mar. 16, 2017.

(51) Int. Cl. H05H 1/28; H05H 1/34

(52) U.S. Cl. CPC H05H 1/28; H05H 2001/3452; H05H 1/34

(57) ABSTRACT

The design and implementation of a thermally optimized neutrode stack for cascaded plasma guns is provided that reduces the thermal loss to the water while minimizing peak stack temperatures. Optimizing the cooling will permit longer stacks to be used without the penalty of high thermal losses.

### BACKGROUND OF THE INVENTION

This International Application claims the benefit of U.S. Provisional Application No. 62/472,202 filed Mar. 16, 2017, the disclosure of which is expressly incorporated by reference herein in its entirety.

### BACKGROUND OF THE INVENTION

### 1. Field of the Invention

Embodiments are directed to cascade type plasma guns, and more particularly to optimized neutrodes utilized in such cascade type plasma guns.

### 2. Discussion of Background Information

Cascade type plasma guns provide advantages of allowing higher voltages and more stable plasma arcs resulting in more stable gun power. The drawback of such guns is the heat rejection resulting from the plasma arc traveling down a relatively long neutrode stack results in higher thermal losses and limits the practical length of the neutrode stack. Longer stacks result in higher thermal losses offsetting the advantages of higher voltages and more stable arcs. What is needed is a structure that optimizes the cooling in order to limit thermal losses without resulting in thermal damage to the neutrode stack.

Current neutrode stacks utilize drilled holes concentrically placed as close as practical to the plasma bore so as to remove heat that would result in damage to the neutrodes, the insulators, or the sealing O-rings. Plasma temperatures inside the plasma bore often exceed 20,000K so cooling of the stack is an essential requirement to prevent damage to the components.

Existing cooling designs for conventional plasma gun nozzles, water cooling channels and/or holes, are typically placed as close to the plasma gun bore as possible to keep temperature of the bore materials as low as possible to prevent damage. This design was carried into the designs for neutrodes as an effective way of cooling.

Recent inventive discoveries covering thermally optimized plasma gun nozzles, e.g., International Application No. PCT/US2013/076603, it was discovered that the nozzle cooling could be altered by moving the water passages away from the plasma gun bore and allow the copper material to move the heat reducing peak temperatures while increasing average temperatures. The water cooling cross section could be reduced to increase water velocity to provide effective cooling sufficient to maintain reasonable temperatures for the plasma gun nozzle while allowing for the increase in average temperature along the bore of the plasma nozzle.

### SUMMARY OF THE EMBODIMENTS

Embodiments of the invention are directed to a structure and method to optimize the cooling of a neutrode stack in order to reduce maximum or peak stack temperatures while reducing the heat losses to the cooling water at the same time.

A design and implementation of a thermally optimized neutrode stack for cascaded plasma guns is provided that reduces the thermal loss to the water while minimizing peak stack temperatures. Optimizing the cooling will permit longer neutrode stacks to be used without the penalty of high thermal losses.

In this regard, the inventors discovered that the technique of moving the water passages away from the plasma gun bore, which allows the copper material of the neutrode to move the heat reducing peak temperatures while increasing average temperatures, could be used on a cascade plasma gun neutrode stack to improve the cooling characteristics without adverse effect on gun behavior.

Embodiments of the invention are directed to a neutrode of a plasma gun that includes a disk-shaped body having an outer peripheral surface and an inner bore; and a plurality of cooling channels formed at least one of in or on the outer peripheral surface.

According to embodiments, the cooling channels can be square shaped. In alternative embodiments, the cooling channels can have a flattened profile with a width more than eight times greater than a depth. Further, in embodiments, the cooling channels are defined by a depth dimension below the outer peripheral surface and a base dimension normal to the depth dimension. A ratio of base to depth for the cooling channels is within a range of ratios between 1:1-8:1.

In accordance with embodiments, the cooling channels can be structured to provide an average water velocity through the channels of less than 8.0 m/sec and at least one of: greater than 1.0 m/sec, greater than 2.0 m/sec, and greater than 3.0 m/sec.

Embodiments are directed to a plasma gun that includes a neutrode stack having a plurality of the above-described neutrodes.

According to embodiments, adjacent neutrodes in the neutrode stack may be electrically isolated from each other. The plasma gun may further include an insulation layer arranged between the adjacent neutrodes. In embodiments, the plasma gun can further include a sealing element layer arranged to form a water barrier between the adjacent neutrodes. In other embodiments, the plasma gun can also include a gas gap formed between the adjacent neutrodes. In other embodiments, each of the plurality of neutrodes can have a same number of cooling channels, and the plurality of neutrodes may be arranged so that the cooling channels are axially aligned. Further, circumferential cooling channels can be formed between the adjacent neutrodes.

In accordance with embodiments of the invention, the plurality of neutrodes, while physically separated from each other, can be clamped together under force.

Embodiments are directed to a method of forming a neutrode of a plasma gun that includes forming a plurality of water cooling channels at least one of in or on an outer peripheral surface of a disk-shaped body with an inner bore.

According to embodiments, the plurality of water cooling channels can be structured to provide an average water velocity through the channels of less than 8.0 m/sec and at least at least one of: greater than 1.0 m/sec, greater than 2.0 m/sec, and greater than 3.0 m/sec. In further embodiments, the method can include forming a plurality of water cooling channels at least one of in or on an outer peripheral surface of at least one additional disk-shaped body with an inner bore and coaxially aligning the disk-shaped body and the at least one additional disk-shaped body along the inner bores. In embodiments, the method can also include electrically isolating the disk-shaped body from an adjacent one of the at least one additional disk-shaped body. In other embodiments, the disk-shaped body can be separated from the adjacent one of the at least one additional disk-shaped body by at least one of an insulating layer; a gas gap; and a sealing element. In embodiments, each of the disk-shaped body and the at least one additional disk-shaped body may have a same number of water cooling channels, and the method can further include axially aligning the water cooling channels of the coaxially aligned disk-shaped body and at least one additional disk-shaped body. In still further embodiments, the method can include clamping the coaxially aligned disk-shaped body and at least one additional disk-shaped body together as a stacked neutrode for the plasma gun.

In accordance with still yet other embodiments of the present invention, a method of forming a cascade-type plasma gun with a plurality of the neutrodes, as set forth above, includes aligning the plurality of the neutrodes into a neutrode stack, wherein adjacent neutrodes in the neutrode stack are electrically isolated from each other; and placing the neutrode stack in the cascade-type plasma gun under a clamping force in an axial direction of the neutrode stack.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a conventional neutrode of a known cascaded plasma gun;

FIGS. 2A-2E illustrate various views of an exemplary optimized neutrode in accordance with embodiments of the invention;

FIG. 3 illustrates a cross-sectional view of an embodiment of a neutrode stack, which includes a number of the optimized neutrodes depicted in FIG. 2;

FIG. 4 illustrates the embodiment depicted in FIG. 3, in which the outer peripheries of the stacked optimized neutrodes are illustrated; and

FIG. 5 illustrates another embodiment of an optimized neutrode in accordance with embodiments of the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

To further enhance the cooling optimization, a neutrode stack housing may also contain cooling channels for the return water path arranged in the same fashion as the cooling channels in the neutrodes.

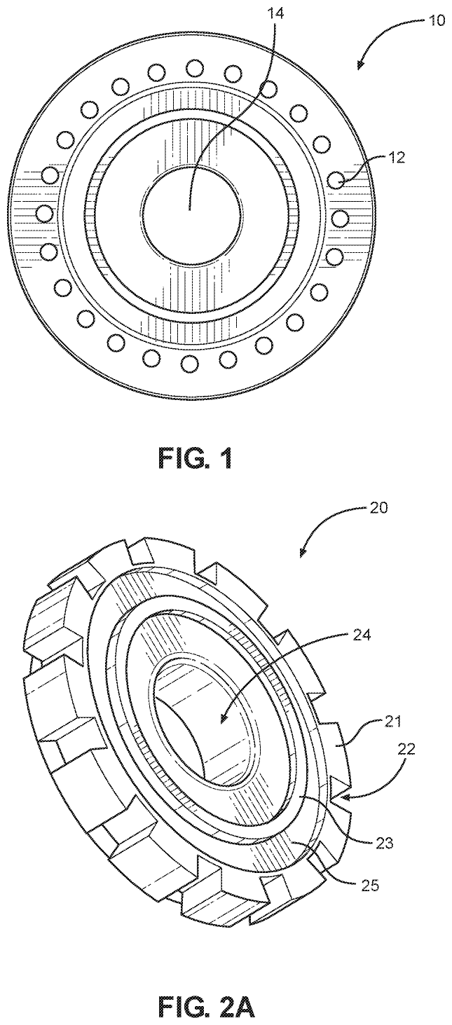

FIG. 1 shows a cross sectional view of a conventional neutrode 10 from an existing cascaded plasma gun. It is apparent that the cooling in the conventional neutrode is provided by twenty four (24) holes 12 arranged around the central plasma bore 14 in proximity to the bore.

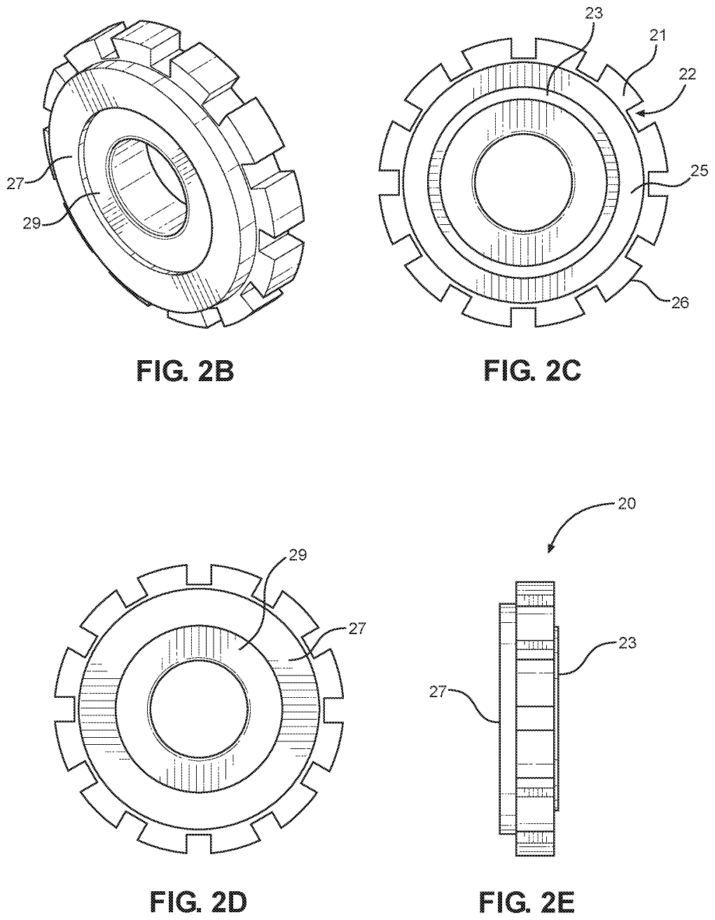

In contrast to the conventional neutrode 10, FIGS. 2A-2E show various views of an exemplary embodiment of a neutrode 20 with twelve (12) axial cooling channels 22 recessed in a body of neutrode 20 and are open to an outer peripheral surface 26 of neutrode 20 surrounding a central plasma bore 24. In this regard, the axially extending through recesses extend outwardly to define protrusions 21, which include portions of outer peripheral surface 26, such that outer peripheral surface 26 is circumferentially discontinuous. On a first side of neutrode 20, e.g., right-hand side shown perspectively in FIG. 2A and shown in plan view in FIG. 2C, a ridge 23 axially extends from a recessed surface 25 located below the right-hand side of protrusions 21. On a second side of neutrode 20, e.g., left-hand side shown perspectively in FIG. 2B and shown in plan view in FIG. 2D, a ridge 27 axially extends from a surface 29, which can be coplanar with the left-hand side of protrusions 21. FIG. 2E depicts a side view of neutrode 20 in which the axial extensions of ridges 23 and 27 extend beyond the planes of the left-hand and right-hand sides of protrusions 21. Further, in the non-limiting illustrated embodiment of FIGS. 2A-2E, the neutrode can generally has a gear shape, except the side walls of cooling channels 22 are preferably parallel to each other. Moreover, in the plan view of FIGS. 2C and 2D, cooling channels 22 exhibit a generally square shape in which a width of the recess, which is preferably constant over its depth, is substantially equal to the depth of the recess.

By way of non-limiting example, when viewed in the plan view depicted in at FIGS. 2C and 2D, channels 22 defined between protrusions 21 and/or recessed in the neutrode body and open to outer peripheral surface 26 have depth and width dimensions defining areas of channels 22. In a non-limiting example, channels 22 can have a base dimension of 0.125″ (3.175 mm) wide by 0.097″ (2.464 mm) deep, which provides a total area of 0.1476 square inches (95.22 mm²). When operated at, e.g., a water flow of twenty two (22) liters per minute, the average water velocity through the channels can be, e.g., 3.8 m/sec. Moreover, as it is understood that the dimensions and/or geometry of the cooling channels formed can be changed according to embodiments to achieve a desired cooling effect, it is understood that the average water velocity through the channels is less than 8.0 msec. However, as noted above, these values for the channel are merely exemplary and the number and size of cooling channels 22 formed between protrusions 21 and/or recessed below and open to outer peripheral surface 26 of neutrode 20 depends upon the water flow needed to prevent temperatures from reaching levels that could damage the gun. By way of further example, channels 22 can be formed to be understood to be substantially square shaped in that the dimension for the depth is substantially the same as the dimension for the width, which is preferably a constant width, of channels 22. Further, while the substantially square shaped channels have a generally 1:1 ratio of width dimension forming a base of the channels to depth dimension below the outer peripheral surface, it is further understood that the ratio of width to depth for the cooling channels can vary within a range of ratios between 1:1-8:1.

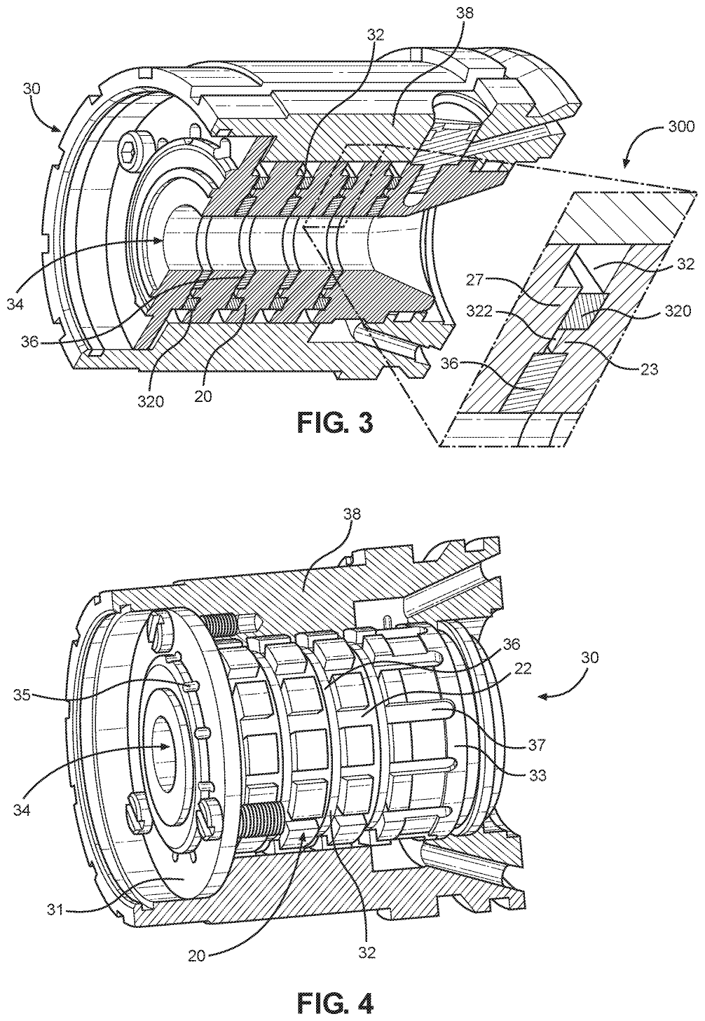

FIG. 3 shows a cross-sectional view of an exemplary neutrode stack 30 in a neutrode housing 38, which includes a plurality of the optimized neutrodes 20 depicted in FIG. 2, which are coaxially stacked together, and FIG. 4 shows an alternative view of FIG. 3, in which the outer peripheries 26 of components within a cross-sectional view of neutrode stack housing 38, including the outer peripheries of the stacked optimized neutrodes 20, are shown. In the illustrated embodiments, when viewed from the left-hand side of neutrode stack 30, neutrodes 20 depicted in FIG. 2, can be located in, e.g., the second, third and fourth positions. However, the individual neutrodes 20 are isolated from each other, e.g., electrically isolated and physically spaced, so that adjacent neutrodes 20 do not contact each other in neutrode stack 30. Further, neutrode housing 38 can be made of, e.g., plastic, to likewise maintain the isolation between adjacent neutrodes 20 in neutrode stack 30.

As shown in FIG. 3, neutrodes 20 are concentrically aligned along central plasma bores 24 to form neutrode stack 30. In an advantageous and non-limiting embodiment, each neutrode 20 of neutrode stack 30 can have the same number of cooling channels and be oriented so that cooling channels 22 are axially aligned, as depicted in FIG. 4. As neutrodes 20 are isolated from each other in neutrode stack 30, an insulator 36 can be arranged between adjacent neutrodes 20 as a separator. Insulator 36 can be, e.g., boron nitrite, and can be located radially inside ridge 23 and extend radially inwardly to central plasma bore 34 of neutrode stack 30. In embodiments, transitions between central plasma bores 24 of individual neutrodes 20 and insulator 36 within central plasma bore 34 of neutrode 30 can be smooth. As more particularly shown in the inset 300, insulator 36 is suitably thick to maintain an air or gas gap 322 of, e.g., about 0.030″ (0.76 mm) between facing surfaces of ridge 23 of a first neutrode 20 and ridge 27 of an adjacent neutrode 20. Further, radially outside of ridge 23, a seal 320, such as an O-ring, which can be made of, e.g., silicon, synthetic rubber such as, e.g., VITON®, nitrile rubber such as BUNA-N, or other suitable water sealing material suited to withstand the temperatures generated within the region of neutrode stack 30, can be arranged between the facing surfaces of adjacent neutrodes 20 in order to cover air or gas gap 322 and, thereby prevent cooling water ingress from the cooling channels radially inwardly into air or gas gap 322.

In the illustrated embodiments, neutrode stack 30 may be sandwiched between a larger diameter disk 31 having cooling water holes 35 and an end piece 33 having cooling channels 37, which can be terminated or blind cooling channels. In advantageous and non-limiting embodiments, disk 31 includes a number of cooling water holes 35, which corresponds to the number of cooling channels 22 in each neutrode 20 and to the number of cooling channels 37 in end piece 33. Further, cooling water holes 35, cooling channels 22 and cooling channels 37 can be oriented so as to be axially aligned, as depicted in FIG. 4. Still further, as the radially extending portions of neutrodes 20 that include peripheral surface 26 are separated from each other in the axial direction, circumferential cooling channels 32 are formed in neutrode stack 30. Moreover, the larger diameter of disk 31 can used, not only for coupling disk 31 to housing 38, e.g., via screws, bolts, clamps, etc., but also to bias disk 31, stacked optimized neutrodes 20 and end piece 33 together. Advantageously, the biasing is sufficient so that seals 320 suitably engage the facing surfaces of adjacent neutrodes to achieve a desired water sealing configuration. In embodiments, it is readily understood that neutrode stack 30 can include more or even fewer of the optimized neutrodes depicted in FIG. 2. Moreover, it is further understood that neutrode stack housing 38 can include similar cooling channels formed in or on the outer periphery of the housing.

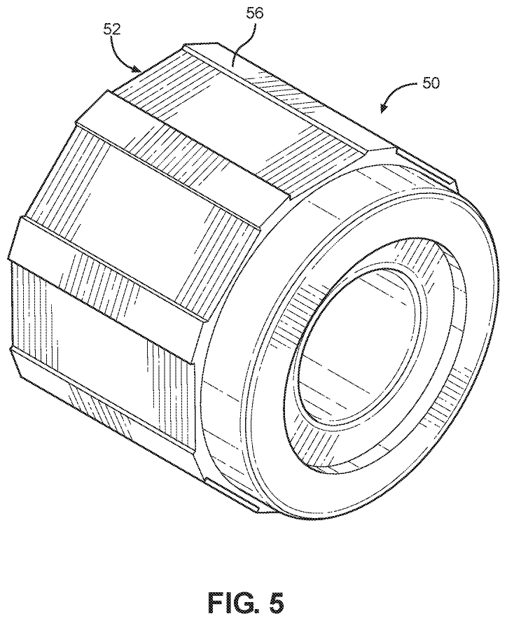

FIG. 5 shows another exemplary embodiment of a neutrode 50. In this embodiment, neutrode 50 can include eight (8) flattened cooling channels 52 formed in and around the outer periphery 56 of neutrode 50. By way of non-limiting example, flattened channels 52 formed in periphery 56 of neutrode 50 can be 0.200″ (5.08 mm) wide by 0.0225″ (0.572 mm) deep, which provides a total area of 0.032 square inches (20.65 mm²). When operated at a water flow of 9 liters per minute the average water velocity through the channels is 6.4 m/sec. Moreover, as it is understood that the dimensions and/or geometry of the cooling channels formed can be changed according to embodiments to achieve a desired cooling effect, it is understood that the average water velocity through the channels is less than 8.0 m/sec. However, as noted above, these values for the channel are merely exemplary and the number and size of the cooling channels depends upon the water flow needed to prevent temperatures from reaching levels that could damage the gun.

According to embodiments, a neutrode stack can be provided with water cooling channels arranged at an outer perimeter of each optimized neutrode, as shown, e.g., in FIGS. 2A, 5. The cross sectional areas of the channels can be designed to create high water velocities, e.g., greater than 1.0 m/sec, preferably greater than 2.0 m/sec, and most preferably greater than 3.0 m/sec, but which are less than 8.0 m/sec. Each channel can be structured with shapes ranging from a roughly square shape, see, e.g., FIG. 2A-2E, to an elongated and flattened shape, see, e.g., FIG. 5, in order to maximize the water cooling flow at the outermost periphery of the neutrodes 20. Moreover, the channels can also be structured or formed with triangular cross-sections and arranged to maximize the water cooling flow at the outer periphery of each neutrode. The number and size and geometry of the cooling channels are dependent upon the required water flow to prevent temperatures from reaching levels that could damage the gun. The total number of neutrodes in the neutrode stack or thickness of each neutrode of the neutrode stack is not limited in this design. In fact, with the optimized neutrodes according to embodiments, longer neutrode stacks are now possible with limited thermal cooling losses.

It is noted that the embodiments are not limited to the above-described specific examples of base to depth ratios for the cooling channels. It is understood that the ratio of base to depth for the cooling channels can be up to 1:1 to achieve cooling channels ranging from taller radial profiles to a generally square cross-section, greater than 8:1 to achieve a flatter profile cross-sections, and any ratio within the range between 1:1 and 8:1. Thus, the ratio can be, but again is not limited to, specific ratios of base to depth of 2:1, 3:1, 4:1, 5:1, 6:1, 7:1, as well as any ratios therebetween.

In a plasma gun comprising a neutrode stack formed by a plurality of neutrodes 50, water flow in a plasma gun, as computed via known computational fluid dynamics (CFD) software, reveals that with a 8.1 liters per minute water flow, the average water velocity in the neutrode stack was above 3.2 m/sec.

A single arc cascaded plasma gun built with neutrode stack 30, as depicted in FIG. 3, was tested and compared to a conventional plasma gun of the same overall design, which included a long nozzle that used water cooling fins or channels to cool the plasma nozzle. The test results showed a 10% increase in thermal efficiency with the gun using neutrode stack 30 according to the embodiments of the invention over the conventionally cooled nozzle. Other testing showed that adding conventional neutrode stacks to plasma guns reduced thermal efficiency from between 6% and 10%. Still further testing showed that doubling the length of a conventional neutrode stack for a plasma gun reduced thermal efficiency by 20% while increasing the length of neutrode stack 30 with added optimized neutrodes 20 had a much lower decrease in thermal efficiency, which worked out to be about less than one-half that of conventional neutrode stacks. Moreover, duration testing of neutrode stack 30 showed no adverse thermal effects even after more than 200 hours of testing with the same stack.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A neutrode of a plasma gun comprising:
a disk-shaped body having an outer peripheral surface and an inner bore; and
a plurality of cooling channels formed in the disk-shaped body as recesses open to the outer peripheral surface.

2. The neutrode in accordance with claim 1, wherein the cooling channels are square shaped.

3. The neutrode in accordance with claim 1, wherein the cooling channels have a flattened profile with a width more than eight times greater than a depth.

4. The neutrode in accordance with claim 1, wherein the cooling channels are defined by a depth dimension below the outer peripheral surface and a base dimension normal to the depth dimension, wherein a ratio of base to depth for the cooling channels is within a range of ratios between 1:1-8:1.

5. The neutrode in accordance with claim 1, wherein the cooling channels are structured to provide an average water velocity through the channels of less than 8.0 m/sec and at least one of:
greater than 1.0 m/sec,
greater than 2.0 m/sec, and
greater than 3.0 m/sec.

6. A plasma gun comprising:
a neutrode stack comprising a plurality of the neutrodes in accordance with claim 1.

7. The plasma gun in accordance with claim 6, wherein adjacent neutrodes in the neutrode stack are electrically isolated from each other.

8. The plasma gun in accordance with claim 7, further comprising an insulation layer arranged between each of the adjacent neutrodes.

9. The plasma gun in accordance with claim 7, further comprising a sealing element layer arranged to form a water barrier between each of the adjacent neutrodes.

10. The plasma gun in accordance with claim 7, further comprising a gas gap formed between each of the adjacent neutrodes.

11. The plasma gun in accordance with claim 7, wherein each of the plurality of neutrodes has a same number of cooling channels, and the plurality of neutrodes are arranged so that the cooling channels are axially aligned.

12. The plasma gun in accordance with claim 11, further comprising circumferential cooling channels formed between each of the adjacent neutrodes.

13. The plasma gun in accordance with claim 6, wherein the plurality of neutrodes, while physically separated from each other, are clamped together under force.

14. A method of forming a neutrode of a plasma gun, comprising:
forming a plurality of water cooling channels open to an outer peripheral surface of a disk-shaped body with an inner bore.

15. The method according to claim 14, wherein the plurality of water cooling channels are structured to provide an average water velocity through the channels of less than 8.0 m/sec and at least at least one of:
greater than 1.0 m/sec,
greater than 2.0 m/sec, and
greater than 3.0 m/sec.

16. The method according to claim 14, further comprising:
forming a plurality of water cooling channels at least one of in or on an outer peripheral surface of at least one additional disk-shaped body with an inner bore; and
coaxially aligning the disk-shaped body and the at least one additional disk-shaped body along the inner bores.

17. The method according to claim 16, further comprising electrically isolating the disk-shaped body from an adjacent one of the at least one additional disk-shaped body.

18. The method according to claim 17, wherein the disk-shaped body is separated from the adjacent one of the at least one additional disk-shaped body by at least one of an insulating layer; a gas gap; and a sealing element.

19. The method in accordance with claim 16, wherein each of the disk-shaped body and the at least one additional disk-shaped body have a same number of water cooling channels, and the method further comprises axially aligning the water cooling channels of the coaxially aligned disk-shaped body and at least one additional disk-shaped body.

20. The method in accordance with claim 16, further comprising clamping the coaxially aligned disk-shaped body and at least one additional disk-shaped body together as a stacked neutrode for the plasma gun.

21. A method of forming a cascade-type plasma gun with a plurality of the neutrodes in accordance with claim 1, comprising:
aligning the plurality of the neutrodes into a neutrode stack, wherein adjacent neutrodes in the neutrode stack are electrically isolated from each other; and
placing the neutrode stack in the cascade-type plasma gun under a clamping force in an axial direction of the neutrode stack.
